(19) United States
(12) Patent Application Publication
(10) Pub. No.: US 2015/0328921 A1
(43) Pub. Date: Nov. 19, 2015

(54) QUARTZ-LIKE FINISHED COMPOSITE COUNTERTOP AND METHOD OF MANUFACTURING

(71) Applicant: RSI HOME PRODUCTS MANAGEMENT, INC., Anaheim, CA (US)

(72) Inventor: Damian J. Le Duff, Chula Vista, CA (US)

(21) Appl. No.: 14/713,376

(22) Filed: May 15, 2015

Related U.S. Application Data
(60) Provisional application No. 62/000,423, filed on May 19, 2014.

(51) Int. Cl. B44F 9/04; B29C 41/22

(52) U.S. Cl. CPC B44F 9/04; B29C 41/22; B29L 2031/441

(57) ABSTRACT

Disclosed herein is a composite product, such as a countertop, that can have an aesthetic appearance of quartz or engineered stone, and methods for manufacturing the composite product. A combination of an opaque gelcoat and particulates can be applied to a marble backing. Once a portion of the combination is sanded down to expose the particulates, the composite can have a quartz-like finished aesthetic.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

1. Field

The present disclosure is generally related to a composite countertop and a method for manufacturing a composite countertop having similar aesthetics to natural or engineered stone.

2. Description of the Related Art

Engineered stone (or engineered quartz) counter tops have been used in the kitchen and bath industry for quite some time, due to their durable characteristics and ease of maintenance. Typically, engineered stone has been used as a replacement for natural stone. Engineered stone is a composite material formed by incorporating crushed stone into a polymer resin (such as epoxy and polyester resin). In many cases, the crushed stone is a mixture that is predominately quartz, e.g. over 90% of the final material is quartz. Other fillers, such as colored glass, shells, metals, or mirrored materials can also be added. The composite is then cured together to form hardened slabs. Engineered stone has traditionally been produced by using very high heat and pressure to cure the quartz and resin mix into the hardened slabs. After curing, the slabs are cut or machined into individual pieces, and the pieces are then polished to the appropriate finish. The cutting process for the engineered stone is time consuming and expensive as the large slabs need to be cut in a similar way as natural stone. Therefore, water jet cutters or diamond blades are required for breaking down the slabs into the desired size. The costs of the products produced from the traditional engineered stone process are very expensive due to the large capital investment to purchase the equipment.

### SUMMARY

Disclosed herein are embodiments of a composite material which can comprise a backing material forming a generally solid structural shape, and a coating at least partially covering the backing material on at least one surface, the coating comprising a mixture of a gelcoat and a plurality of particulates, wherein at least some of the plurality of particulates are exposed at the at least one surface of the composite material, and wherein the gelcoat is opaque.

In some embodiments, the backing material can comprise marble. In some embodiments, the composite material can be a tile. In some embodiments, the composite material can be a countertop. In some embodiments, the coating can be 50 mils or less in thickness.

In some embodiments, the gelcoat can comprise a polyester. In some embodiments, the plurality of particulates can comprise thermoplastic, thermoset, or combinations thereof. In some embodiments, the composite material can be stain resistant and chemical resistant. In some embodiments, the gelcoat may not transmit visible light.

In some embodiments, the plurality of particulates can be 18 Mesh or less. In some embodiments, the plurality of particulates can have a density equal to or less than the density of the gelcoat.

Also disclosed herein are embodiments of a method of making a composite material which can comprise mixing an opaque gelcoat with a plurality of particulates to form a mixture, applying a thickness of the mixture to a mold, applying a backing material to the mold on top of the applied mixture to form an uncured composite, curing the uncured composite to form a cured composite, removing the cured composite from the mold, and sanding the cured composite on a side with the mixture, wherein at least some of the plurality of particulates are exposed. In some embodiments, the method can further comprise polishing the sanded cured composite.

In some embodiments, the curing can occur at ambient temperature. In some embodiments, the curing can occur at ambient pressure.

In some embodiments, the backing material can comprise marble or cultured marble. In some embodiments, the backing material can be a solid. In some embodiments, the backing material can be a liquid.

In some embodiments, the mixture can be applied to a mold at the thickness of 50 mils or less. In some embodiments, the gelcoat can comprise a polyester. In some embodiments, the plurality of particulates can comprise thermoplastic, thermoset, or combinations thereof. In some embodiments, the gelcoat may not transmit any visible light.

In some embodiments, mixing can comprise hand mixing. In some embodiments, applying a thickness of the mixture to a mold can comprise spray coating.

Also disclosed herein are embodiments of a structural base having a countertop, the countertop can comprise a backing material forming a generally solid structural shape, and a coating at least partially covering the backing material on at least one surface, the coating comprising a mixture of a gelcoat and a plurality of particulates, wherein at least some of the plurality of particulates are exposed at the at least one surface of the composite material.

In some embodiments, the coating can be 50 mils or less in thickness. In some embodiments, the gelcoat can comprise a polyester. In some embodiments, the plurality of particulates can comprise thermoplastic, thermoset, or combinations thereof. In some embodiments, the composite material can be stain resistant and chemical resistant. In some embodiments, the plurality of particulates can be 18 Mesh or less.

Also disclosed herein are embodiments of a countertop which can comprise a backing material forming a generally solid structural shape, and a coating at least partially covering the backing material on at least one surface, the coating comprising a mixture of a gelcoat and a plurality of particulates, wherein at least some of the plurality of particulates are exposed at the at least one surface of the composite material.

In some embodiments, the coating can be 50 mils or less in thickness. In some embodiments, the gelcoat can comprise a polyester. In some embodiments, the plurality of particulates can comprise thermoplastic, thermoset, or combinations thereof. In some embodiments, the composite material can be stain resistant and chemical resistant. In some embodiments, the plurality of particulates can be 18 Mesh or less.

Also disclosed herein are embodiments of a composite material comprising a backing material forming a generally solid structural shape and a coating at least partially covering the backing material on at least one surface, the coating comprising a mixture of a gelcoat and a plurality of particulates wherein at least some of the plurality of particulates are exposed at the at least one surface of the composite material, and wherein the gelcoat is configured to transmit less than 5% of visible light.

### BRIEF DESCRIPTION OF THE DRAWINGS

FIG. 1 illustrates an embodiment of a method of manufacturing a composite material.

FIG. 2 illustrates an embodiment of a mold for forming embodiments of a composite material.

FIGS. 3A-B illustrate embodiments of particulate and opaque gelcoat prior to mixing.

FIGS. 4A-C illustrate an embodiment of particulate mixed into an opaque gelcoat before and after applying to the mold.

FIG. 5 illustrates an embodiment of a backing matrix being cast into a mold.

FIGS. 6A-B illustrate both sides of the composite part before sanding.

FIGS. 7A-B illustrate an embodiment of a grinding tool and a surface of an embodiment of a composite material after sanding.

FIGS. 8A-B illustrate an embodiment of the material after finish sanding and polishing.

FIGS. 9A-C illustrate an example of a countertop/cabinet which can incorporate embodiments of the disclosed composite.

### DETAILED DESCRIPTION

Disclosed herein is a quartz-like finished coating and/or composite counter or vanity top, and methods of manufacturing. Specifically, the disclosed composite material can be quickly, easily, and cheaply manufactured so that it has similar aesthetics to quartz counter or vanity tops, such as counter or vanity tops of engineered or natural stone. While the preferred product is a composite countertop for kitchens and/or bathrooms, the end product does not limit the disclosure. Advantageously, the disclosed composite countertop can have a similar aesthetic finish as engineered stone or quartz, but can cost substantially less than engineered stone to produce. Further, the disclosed composite countertop can be substantially lighter than engineered stone, allowing for a user to more easily transport and place the composite material than engineered stone. Engineered stone density is 92% quartz and 8% polyester resin, however, embodiments of the disclosed composite can be made of a cultured marble matrix, or cultured marble, which can be much lighter, especially as light weight fillers can be used. Cultured marble is a man-made product having a mixture of stone materials suspended in a matrix. In some embodiments, fiber glass, ATH, or other light weight fillers can be used, and the type of filler does not limit the disclosure.

In some embodiments, the composite material can be made of a number of different materials. The first material can be a backing matrix, which can act as a support structure to give a general shape, and provide strength and rigidity, to the overall composite material. In some embodiments, the backing matrix can be, for example, marble, cultured marble, wood, or polyester resin, ATH, calcium sulfate, and calcium carbonate. In some embodiments, calcium carbonate with polyester resin can be used to form a cultured marble backing matrix. The type of backing matrix material does not limit the disclosure and, for example, metal, ceramic, or polymers can be used as the backing matrix. As discussed below, the backing material or matrix can be formed in any size and shape desired by a user as the backing material desirably does not affect the color or look of the finished product. The backing material can be formed of a lighter, or less dense material, than is typically used to form a countertop. In some embodiments, the backing material can include fillers, such as lightweight fibers and/or chop fibers.

The backing matrix can be at least partially coated by a mixture of particulates, or chips or aggregates, embedded into a polymer, or gelcoat, material, which can be known as a topcoat. Once the particulates are exposed at an outer surface of the composite, the composite can have a similar aesthetic as engineered and natural stone. However, in some embodiments, prior to exposure through sanding, the particulates cannot be seen in the gelcoat. Further, embodiments of the disclosed composite material can be stain and chemical resistant, and thus it can be used in similar applications as engineered and natural stone. For example, the disclosed composite material can be used as countertop material that will interact with different food, liquids, and chemicals with minimal deleterious consequences to the composite material.

In some embodiments, the particulates can be made of a polymer material, such as a thermoplastic or thermoset. The particulates can be man-made or natural. In some embodiments, the particulates can be glass, mirror, metal flakes, stones, or corn husks. In some embodiments, the particulates can be made of aluminum try-hydrate, titanium dioxide, and filler. In some embodiments, the aluminum try-hydrate can be 50-97 wt. %, the titanium dioxide can be <1.0 wt. %, and the filler can be 3-20 wt. %. However, the composition and proportions of the particulate do not limit the disclosure.

The particulates can vary in size, and the size of the particulates does not limit the disclosure. In some embodiments, the particulates can be crushed and/or ground to a particulate shape or size. In some embodiments, the composite material can contain particulates of varying sizes. In some embodiments, the composite material can contain particulates that are roughly the same in size. In some embodiments, the particulates can be about 6, 8, 10, 12, 14, 16, or 18 Mesh particulates. In some embodiments, the particulates can be less than about 6, 8, 10, 12, 14, 16, or 18 Mesh particulates. In some embodiments, the particulates can be greater than about 18, 16, 14, 12, 10, 8, or 6 Mesh particulates. In some embodiments, the particulates can be about 1/10, ⅛, ⅙, ¼, or ½″. In some embodiments, the particulates can be greater than about 1/10, ⅛, ⅙, ¼, or ½″. In some embodiments, the particulates can be less than about 1/10, ⅛, ⅙, ¼, or ½″. In some embodiments, at least about 10%, 20%, 30%, 40%, or 50% are above a given size and the remainder being lower to or equal to a given size, the given size being about 6, 8, 10, 12, 14, 16, or 18 Mesh.

As mentioned above, the particulates can be embedded in a gelcoat. In some embodiments, the particulates are suspended within the gelcoat so they are not exposed to the outside of the gelcoat. For example, the particulates can have a density that is less than or approximately equal to the density of the gelcoat, thus allowing the particulates to be suspended in the gelcoat without being exposed to the surface prior to any sanding, as discussed below. The gelcoat can generally be formed from a curable material, such as an epoxy or polyester resin or acrylic resin. In some embodiments, the gelcoat is a high grade polyester resin. In some embodiments, the gelcoat can be a Low VOC Gelcoat manufactured by Dura Technologies, Inc. In some embodiments, the gelcoat can be <34.5 wt. % styrene and <0.3 wt. % Naptha. The material and composition of the gelcoat does not limit the disclosure.

In some embodiments, the gelcoat can be generally opaque or a solid color (e.g., pigmented and/or tinted). In some embodiments, the gelcoat can be partially opaque. In some embodiments, the gelcoat can be fully opaque. In some embodiments, the gelcoat can be generally clear so that a user can see through the gelcoat.

The opaqueness of the gelcoat can be defined in a number of ways. For example, the opaque gelcoat can be not transparent and/or translucent, so a user cannot see through the gelcoat to view the particulates within. In some embodiments, the opaqueness of the gelcoat can be defined as the transmission of visible light, e.g., transmissivity of the, gelcoat. In some embodiments, the gelcoat can transmit about 25%, 20%, 15%, 10%, 5%, 1%, or 0% of visible light through the gelcoat. In some embodiments, the gelcoat does not transmit light. In some embodiments, the gelcoat can transmit less than about 25%, 20%, 15%, 10%, 5%, or 1% of visible light through the gelcoat. In some embodiments, substantially all, or, visible light is reflected, scattered, or absorbed by the gelcoat. In some embodiments, about 75%, 80%, 85%, 90%, 95%, 99%, or 100% of visible light is reflected, scattered, or absorbed by the gelcoat. In some embodiments, greater than about 75%, 80%, 85%, 90%, 95%, or 99% of visible light is reflected, scattered, or absorbed by the gelcoat. In some embodiments, radiation other than visible light may be reflected, scattered, or absorbed as described above, and the type of radiation does not limit the disclosure. In some embodiments, the gelcoat is sufficiently opaque that the backing material cannot be seen through the gelcoat. In some embodiments, the combination of gelcoat and particulates is sufficiently opaque that the backing material cannot be seen through the gelcoat, regardless of the thickness of the gelcoat. In some embodiments, at a particular thickness the combination of gelcoat and particulates is sufficiently opaque that the backing material cannot be seen through the gelcoat.

Other methods in the prior art have been used to create a quartz-like finish without using engineered stone or marble. However, previously disclosed methods use a transparent gelcoat mixed with any particulates, thus allowing a user to see through the gelcoat to the particulates within. However, this does not produce the same finish as the embodiments disclosed herein having an opaque coating in which the particulates are embedded into. Further, the transparent coating can require a specifically colored backing material to create the quartz-like finished, which is unnecessary in embodiments of the disclosure. Moreover, the transparent coatings of the prior art typically requires substantially thick layers of gelcoat (e.g., 18 to 20 mils when measured with a wet film gauge) in order to form the proper aesthetics, whereas embodiments of the disclosed coatings can be relatively thin, substantially saving in manufacturing costs.

In some embodiments, the gelcoat can have a similar coloring to that of the non-quartz portions of engineered stone. In some embodiments, the gelcoat can be used to provide a high-quality finish on a visible surface of an object, such as a countertop. In some embodiments, the gelcoat can be cured through time at ambient pressure and temperature, and no external pressure and temperature may be needed for curing. In some embodiments, the gelcoat can be oven cured. In some embodiments, the gelcoat can be cured with UV light. During the curing process, the gelcoat can form a series of cross-linked polymers in some embodiments.

In some embodiments, the particular backing material is not necessary in all applications, and the topcoat can be used without a backing matrix. For example, it can be applied directly to a surface, or a plurality of surfaces, which can act as a backing material.

Once all of the materials have been incorporated into a final composite, as discussed below, certain processing steps can be used to expose the particulates in the gelcoat at the surface of the composite material, as the particulates cannot be seen through the opaque gelcoat. This exposure can give more depth to the aesthetics of the composite material. Upon exposure of the particulates, the composite material can take on the aesthetic look of natural or engineered stone.

Additionally, embodiments of the disclosed composite material can be advantageous as it does not require the use of a clear coat on top of the composite material. The disclosed composite material has sufficient structural toughness and other physical properties so that a clear coat is not necessary. Therefore, one less material is needed when applying the composite material, reducing both overall cost and processing requirements. In some embodiments, no transparent material is used with embodiments of the disclosure.

### Method of Forming Composite Product

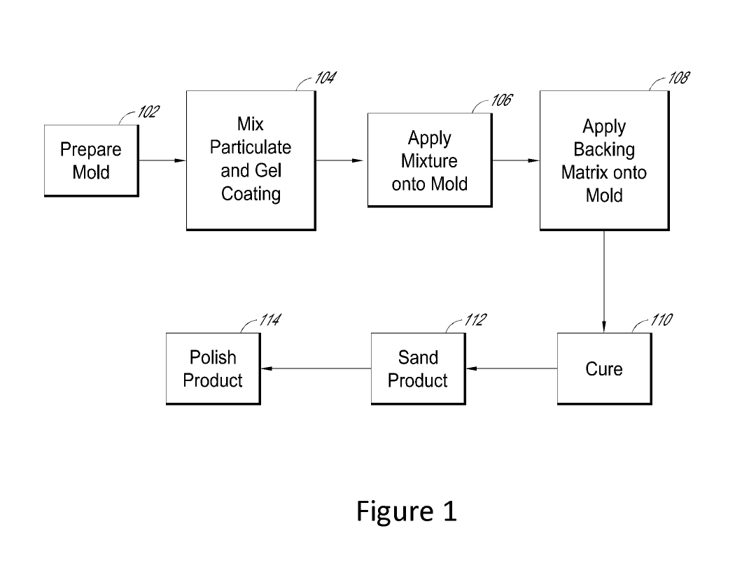

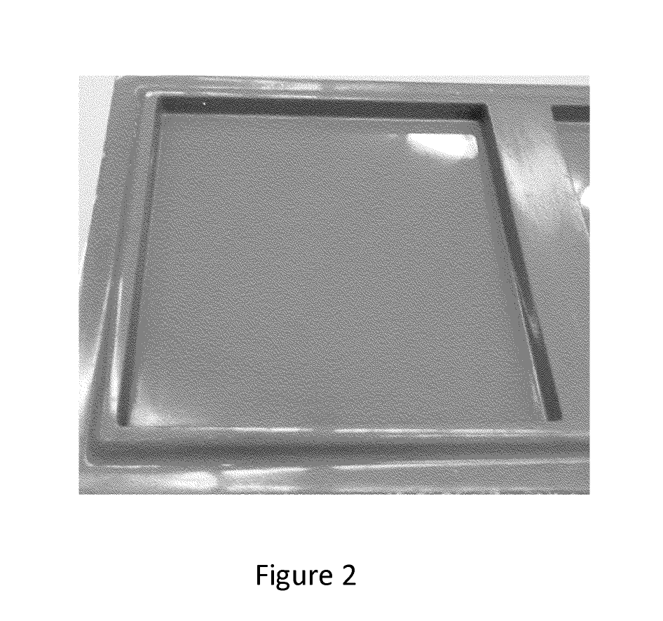

FIG. 1 shows an embodiment of a method of making a composite material of the disclosure. First, a mold can be prepared 102. An example embodiment of a mold is shown in FIG. 2, which shows a mold covered with a semi-permanent release agent. The mold can be sized and configured into any desirable shape for the final composite material. For example, the mold can be generally rectangular. In some embodiments, the mold can have a width and height of approximately 0.5, 1, 2, 3, 4, 5, or 6 feet. In some embodiments, the mold can have a width and height of greater than approximately 0.5, 1, 2, 3, 4, 5, or 6 feet. In some embodiments, the mold can have a width and height of less than approximately 0.5, 1, 2, 3, 4, 5, or 6 feet. In some embodiments, the mold can be between about 0.5, 1, 2, or 3 feet and about 4, 5, or 6 feet. In some embodiments, the mold can have a thickness of approximately ¼, ½, ¾, 1, 2, 3, or 4 inches. In some embodiments, the mold can have a thickness of greater than approximately ¼, ½, ¾, 1, 2, 3, or 4 inches. In some embodiments, the mold can have a thickness of less than approximately ¼, ½, ¾, 1, 2, 3, or 4 inches. In some embodiments, the mold can be sized and shaped in other dimensions, such as an oval, triangle, circle, or hexagon. The size and shape of the mold does not limit the disclosure. The mold can be chosen based on a user's desired size and shape of the final composite produce.

In some embodiments, a release agent can be coated onto the mold. The release agent can be used to prevent the mold from bonding with any materials that are put into the mold. The type of release agent does not limit the disclosure. Therefore, after the finished composite is formed, it can be easily removed from the mold without sticking to the mold. In some embodiments, the mold may be made of a material that is sufficient to not bond with the material, and thus a release agent may not be used.

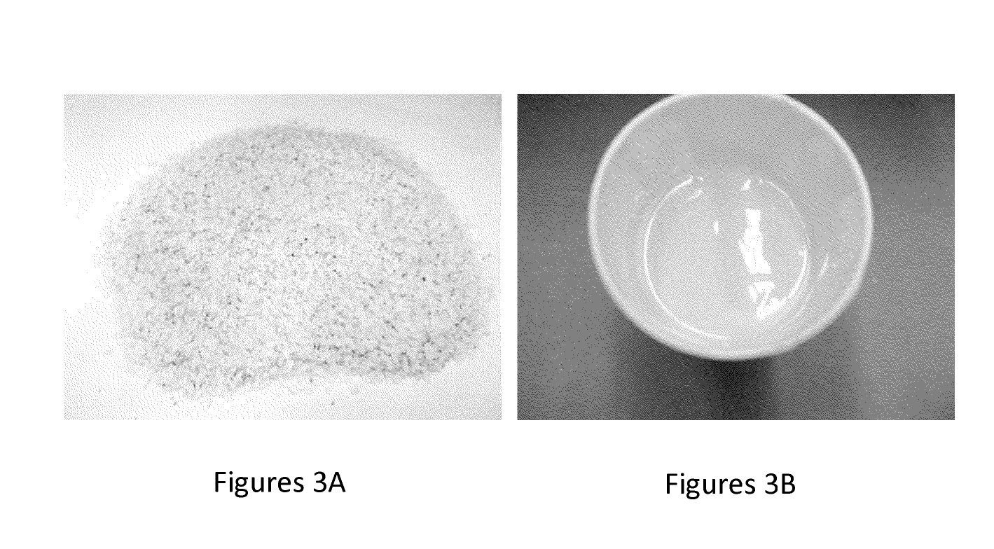

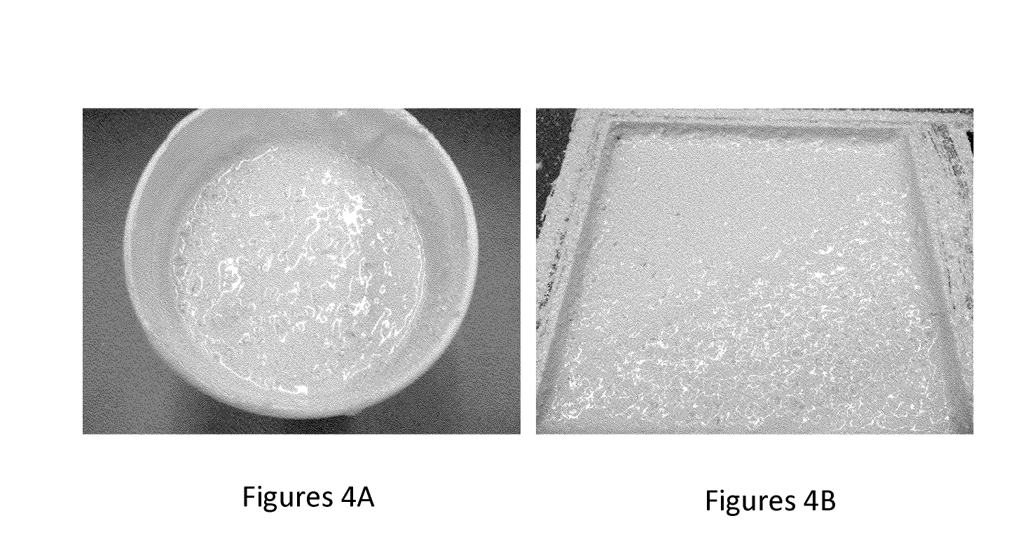

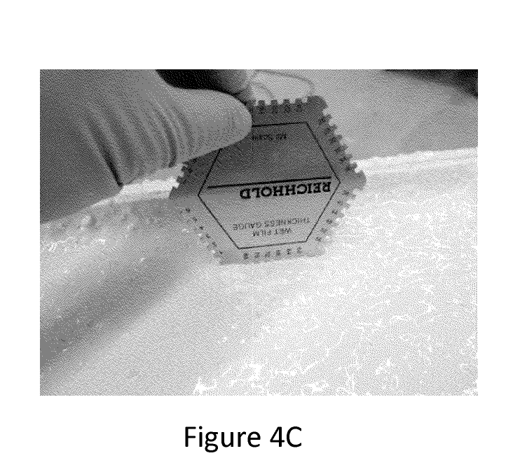

Following, before, or during preparation of the mold, the particulate and gelcoat can be mixed together 104 to form a mixture, or topcoat. In some embodiments, the mixture can be about 1, 2, 3, 4, 5, 10, 15, 20, 25, or 30 wt. % particulate. In some embodiments, the mixture can be greater than about 1, 2, 3, 4, 5, 10, 15, 20, 25, or 30 wt. % particulate. In some embodiments, the mixture can be less than about 1, 2, 3, 4, 5, 10, 15, 20, 25, or 30 wt. % particulate. In some embodiments, the mixture can be from about 1, 2, 3, 4, or 5 to about 10, 15, 20, 25, or 30 wt. % particulate. The particulates are shown in FIG. 3A and the gelcoat is shown in FIG. 3B. More details on embodiments of the particulate and gel are disclosed above. In some embodiments, the gelcoat and particulate are mixed together manually (e.g., by hand). In some embodiments, the gelcoat and particulate are mixed together using a high powered mixer (e.g., by machine). The speed of the mixing does not limit the disclosure. In some embodiments, the particulate and gelcoat can be mixed together to form a generally homogenous mixture. In some embodiments, the mixture may not be homogenous. FIG. 4A shows an embodiment of the gelcoat and particulate mixed together in a container. In some embodiments, as the particulate can have a similar or less density than the gelcoat, the particulate can float in the gelcoat, or is suspended within the gelcoat. Accordingly, the particulates would not sink to the bottom of the mold, which would cause the particulates to be initially exposed when removed from the mold. In some embodiments, the particulate does not float in the gelcoat.

After the particulate and gel are mixed together 104, the mixture can be applied to the mold 106, thus forming an outer surface of the composite material. The mixture can be applied by, for example, spray coating, pouring, painting, roll coating, or other methods, and the method of applying the mixture to the mold does not limit the disclosure. In some embodiments, the mixture is applied to form a layer approximately and, desirably, exactly 5, 10, 15, 20, 30, 40, 50, 55, 60, 70, 80, 90, 100, 150, 200, 250, 300, 350, 400, 450, or 500 mils thick. In some embodiments, the mixture is applied to form a layer greater than approximately and, desirably, exactly 5, 10, 15, 20, 30, 40, 50, 55, 60, 70, 80, 90, 100, 150, 200, 250, 300, 350, 400, 450, or 500 mils thick. In some embodiments, the mixture is applied to form a layer less than approximately and, desirably, exactly 5, 10, 15, 20, 30, 40, 50, 55, 60, 70, 80, 90, 100, 150, 200, 250, 300, 350, 400, 450, or 500 mils thick. In some embodiments, the mixture is applied to form a layer between approximately and, desirably, exactly 10, 20, 30, 40, or 50 and approximately and, desirably, exactly 55, 60, 70, 80, 90, or 100 mils thick. In some embodiments, the layer is applied at a sufficient thickness and viscosity so that the layer does not sag when moved into a vertical position. After applying the mixture, in some embodiments the mixture can be smoothed onto the mold. In some embodiments, after applying the mixture, the mixture is not smoothed. In some embodiments, the mold is coated evenly with the mixture. FIGS. 4B-C show a mold coated by the particulate and gel mixture.

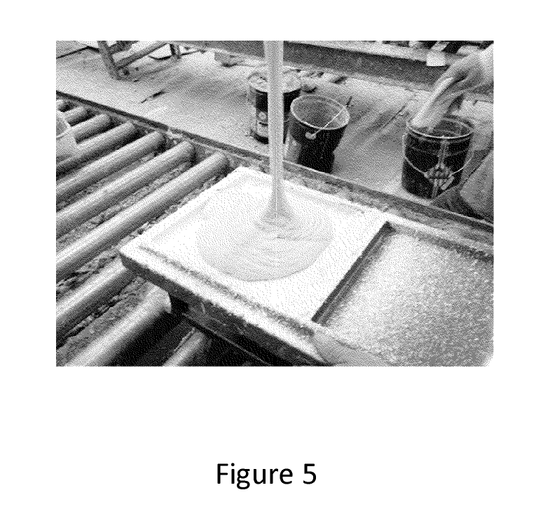

After the mixture is applied to the mold 106, a backing matrix can then be applied to the mold 108 on top of the particulate and gelcoat mixture. The backing matrix can be, for example, marble or cultured marble, though the type of backing matrix is not limiting. In some embodiments, the backing matrix can be in liquid, slurry, or viscous form and can be applied to the mold through pouring, brushing, roll coating, and/or spray coating. FIG. 5 illustrates the backing matrix being poured into the mold. In some embodiments, the backing matrix can be solid and can be placed onto the mold. In some embodiments, the backing matrix can have a thickness of approximately ⅛, ¼, ½, ¾, 1, 2, 3, or 4 inches. In some embodiments, the backing matrix can have a thickness of greater than approximately ⅛, ¼, ½, ¾, 1, 2, 3, or 4 inches. In some embodiments, the backing matrix can have a thickness of less than approximately ⅛, ¼, ½, ¾, 1, 2, 3, or 4 inches.

After the backing is applied to the mold, the particulate and gelcoat mixture can cover at least one face of the backing matrix. In some embodiments, the mixture can cover both the front and the sides of the backing matrix, so that only the back of the backing matrix is exposed. In some embodiments, more of the mixture can be used to coat the back of the backing matrix as well, thereby completely covering the backing matrix with the mixture. In some embodiments, the mixture can form a veneer over or on top of the backing matrix.

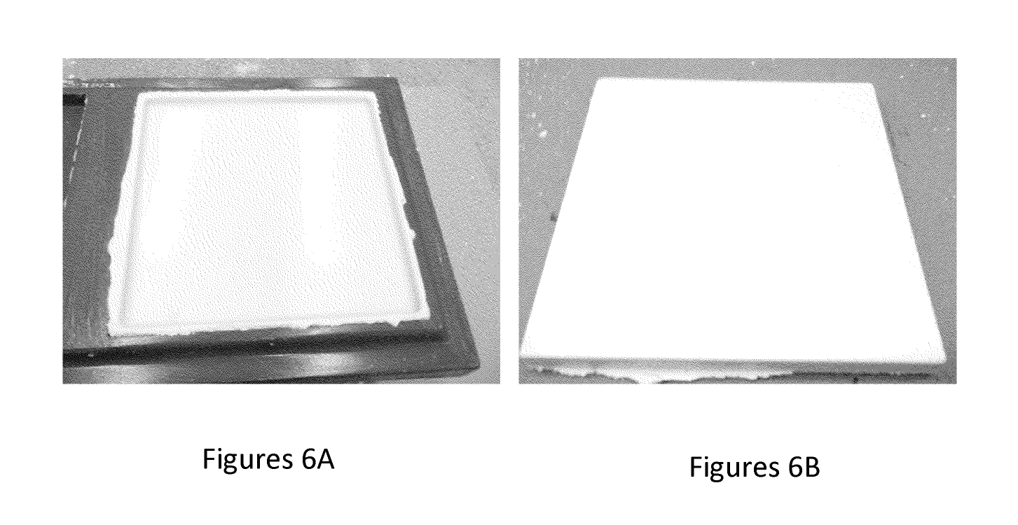

After the matrix has been applied to the mold 108, the matrix and mixture can then be cured. During curing, the particulate and gelcoat mixture can bond with the backing matrix, forming one solid structure. In some embodiments, the combination is cured by time. In some embodiments, heat can be added to expedite the curing process. Once the combination is cured, or partially cured, the composite product can be removed from the mold. FIGS. 6A-B show the front and back of the cured combination. As shown, the particulates embedded in the gelcoat may not be seen upon curing of the composite material due to the opaqueness of the gelcoat. In some embodiments, the final product can have a thickness of approximately ⅛, ¼, ½, ¾, 1, 2, 3, or 4 inches. In some embodiments, the final product can have a thickness of greater than approximately ⅛, ¼, ½, ¾, 1, 2, 3, or 4 inches. In some embodiments, the final product can have a thickness of less than approximately ⅛, ¼, ½, ¾, 1, 2, 3, or 4 inches.

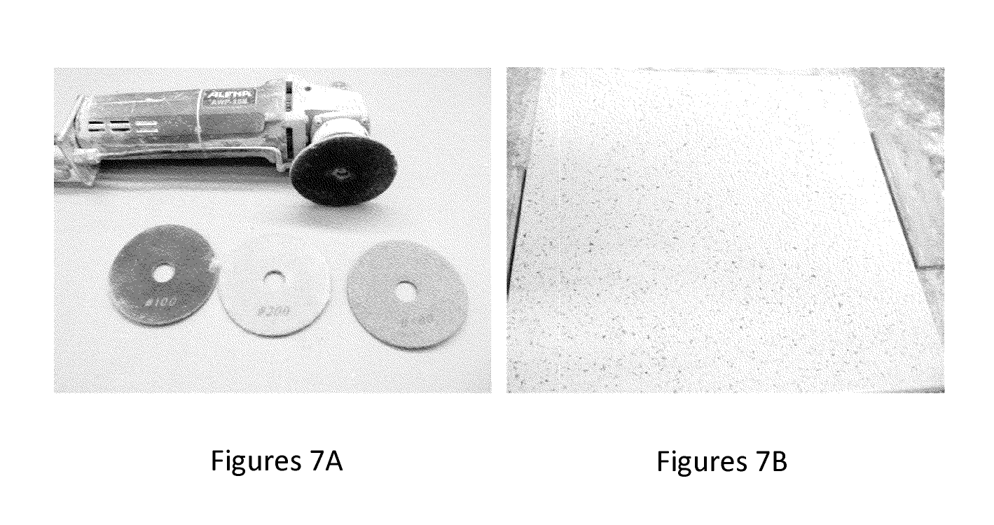

Upon curing, the composite material be finished in order to make the surface appear similar, or substantially similar, to natural or engineered stone. First, the composite can be sanded 110 across the gelcoat layer, such as with the sander shown in FIG. 7A. In some embodiments, a #60, 80, 100, 150, 240, or 320 diamond disc can be used for the sanding process. In some embodiments, greater than a #60, 80, 100, 150, 240, or 320 diamond disc can be used for the sanding process. In some embodiments, less than a #60, 80, 100, 150, 240, or 320 diamond disc can be used for the sanding process. In some embodiments, a diamond disc between #60, 80, or 100 and 150, 240, or 320 can be used for the sanding process. In some embodiments, a sanding machine can be used. The sanding can cut through the aggregates and can remove excess gelcoat to expose the particulates, which would not ordinarily be seen without removal of the gelcoat. The particulate showing through the gelcoat can result in an aesthetic appearance similar to that of quartz and/or engineered stone and/or natural stone, as shown in FIG. 7B. As mentioned above with respect to FIGS. 6A-B, until sanding the composite material may not have the appearance of quartz. If sanded, however, the unexpected quartz finish can appear.

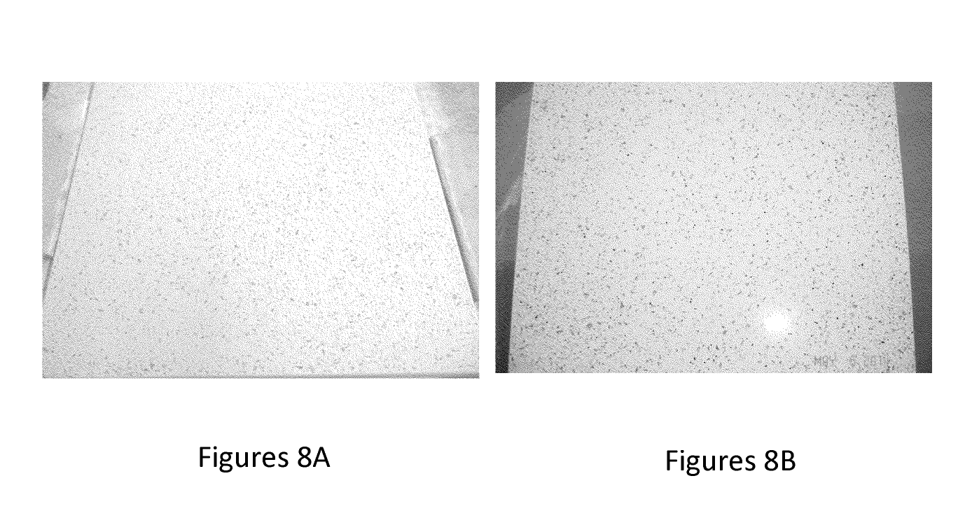

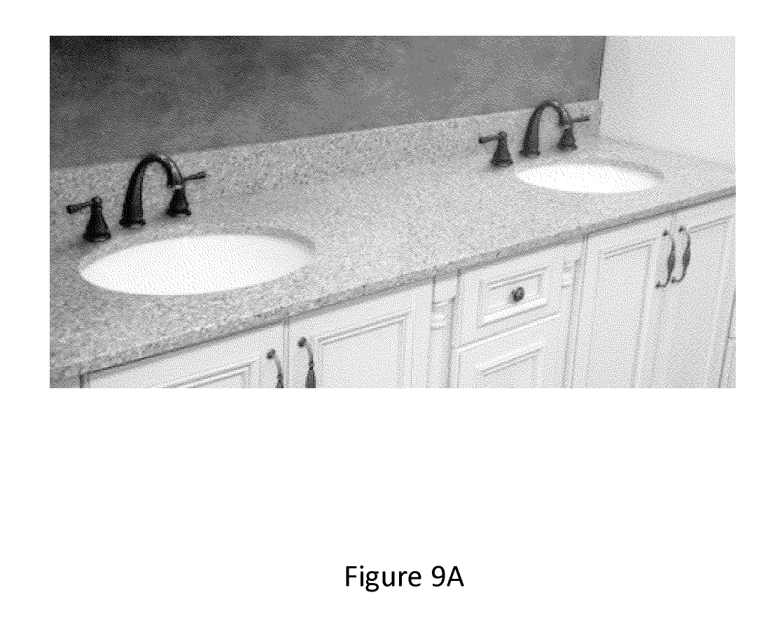

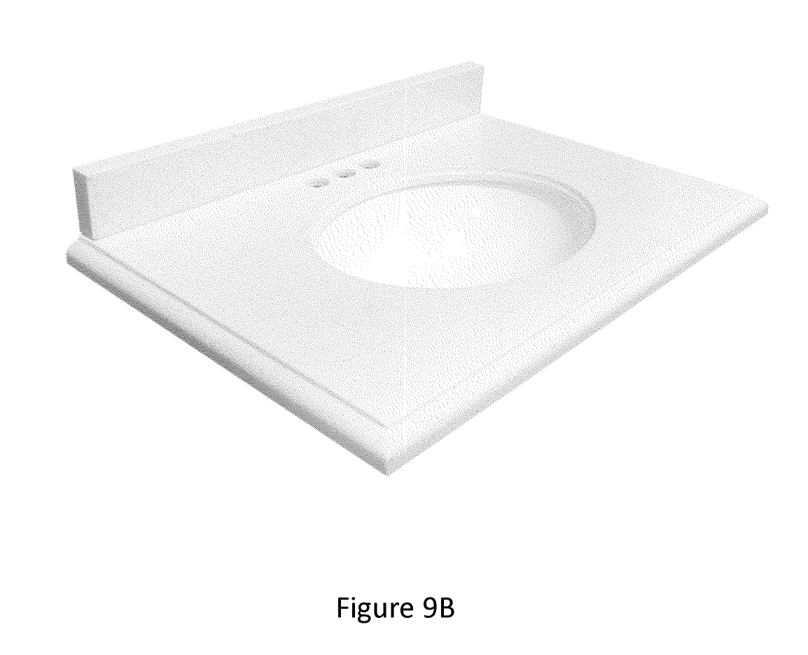

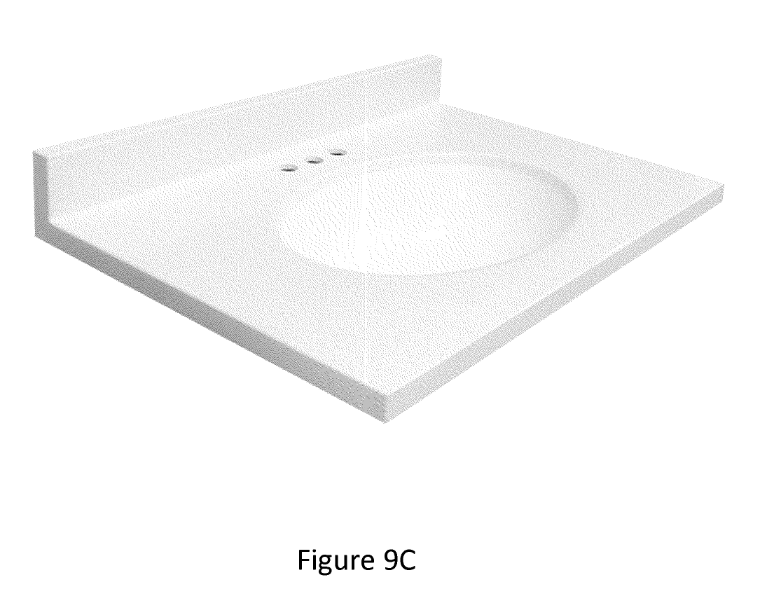

Once sanded 110, the composite product can go through a final finishing process 112. For example, in some embodiments the composite product can be finish sanded and/or buffed. In some embodiments, a series of sandpapers can be used for the finish sanding, such as 200 grit, 400 grit, and 600 grit wet/dry sandpaper. After finish sanding, the composite can then be polished. The final finishing can form a smooth outer layer on the composite product. In some embodiments, all bumps and discontinuities can be removed from the composite product. This can minimize bacterial growth on the composite material. FIGS. 8A-B show the finished composite produced after sanding and polishing. The composite product can then be used, for example, in a kitchen, bathroom, and/or vanity countertop as shown in FIGS. 9A-C.

Embodiments of the above described process can have significant advantages over the processes for forming other similar aesthetic materials, such as engineered stone. In forming engineered stone, huge presses are needed to form blocks. These presses apply high temperatures and high pressures to form the engineered stone. However, advantageous, the above described process eliminates the need for high temperature and pressure in the formation of a product that is aesthetically similar to that of engineered stone. Accordingly, embodiments of the above disclosed process are much cheaper than the process to form engineered stone, and do not require the use of costly equipment to make sheets and to machine the final products, while still making a final product with similar aesthetic appeal to a user. Further, as the disclosed composite can be a casted product, there is no, or minimal, waste or yield lost like when fabricating engineered stone.

From the foregoing description, it will be appreciated that an inventive product and approaches for manufacturing a quartz-like finished composite coating are disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

Some embodiments have been described in connection with the accompanying drawings. The figures are drawn to scale, but such scale should not be limiting, since dimensions and proportions other than what are shown are contemplated and are within the scope of the disclosed inventions. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. A composite material comprising:
a backing material forming a generally solid structural shape; and
a coating at least partially covering the backing material on at least one surface, the coating comprising a mixture of a gelcoat and a plurality of particulates;
wherein at least some of the plurality of particulates are exposed at the at least one surface of the composite material; and
wherein the gelcoat is opaque.

2. The composite material of claim 1, wherein the backing material comprises marble or a cultured marble matrix.

3. The composite material of claim 1, wherein the plurality of particulates have a density equal to or less than the density of the gelcoat.

4. The composite material of claim 1, wherein the composite material is a countertop.

5. The composite material of claim 1, wherein the coating is ¼″ or less in thickness.

6. The composite material of claim 1, wherein the gelcoat comprises a polyester.

7. The composite material of claim 1, wherein the plurality of particulates comprises thermoplastic, thermoset, or combinations thereof.

8. The composite material of claim 1, wherein the composite material is stain resistant and chemical resistant.

9. The composite material of claim 1, wherein the plurality of particulates are 18 Mesh or less.

10. The composite material of claim 1, wherein the plurality of particulates is ¼″ or less.

11. The composite material of claim 1, wherein the gelcoat does not transmit any visible light.

12. A method of making a composite material comprising:
mixing an opaque gelcoat with a plurality of particulates to form a mixture;
applying a thickness of the mixture to a mold;
applying a backing material to the mold on top of the applied mixture to form an uncured composite;
curing the uncured composite to form a cured composite;
removing the cured composite from the mold; and
sanding the cured composite on a side with the mixture, wherein at least some of the plurality of particulates are exposed by the sanding.

13. The method of claim 12, further comprising polishing the sanded cured composite.

14. The method of claim 12, wherein the curing occurs at ambient temperature.

15. The method of claim 12, wherein the curing occurs at ambient pressure.

16. The method of claim 12, wherein the mixture is applied to a mold at the thickness of ¼″ mils or less.

17. The method of claim 12, wherein the gelcoat comprises a polyester.

18. The method of claim 12, wherein the plurality of particulates comprises thermoplastic, thermoset, or combinations thereof.

19. The method of claim 12, wherein applying a thickness of the mixture to a mold comprising spray coating.

20. The method of claim 12, wherein the gelcoat does not transmit any visible light.

21. A composite material comprising:
a backing material forming a generally solid structural shape; and
a coating at least partially covering the backing material on at least one surface, the coating comprising a mixture of a gelcoat and a plurality of particulates;
wherein at least some of the plurality of particulates are exposed at the at least one surface of the composite material; and
wherein the gelcoat is configured to transmit less than 5% of visible light.
